(19) United States
(12) Patent Application Publication
(10) Pub. No.: US 2004/0155227 A1
(43) Pub. Date: Aug. 12, 2004

(54) Conductive paste, article produced therewith with a conductive coating on glass, ceramic or enameled steel and method for the production thereof

(76) Inventors: Artur Bechtloff, Hainburg (DE); Axel Niemann, Frankfurt (DE); Stephan Schreiber, Hanau (DE)

Correspondence Address: RANKIN, HILL, PORTER & CLARK, LLP, 925 EUCLID AVENUE, SUITE 700, CLEVELAND, OH, 44115-1405, US

(21) Appl. No.: 10/473,715

(22) PCT Filed: Feb. 15, 2002
(86) PCT No.: PCT/EP02/01652

(30) Foreign Application Priority Data
Apr. 4, 2001 (DE) 101 16 653

(51) Int. Cl. H01B 1/00

(52) U.S. Cl. 252/500

(57) ABSTRACT

The invention relates to a conductive paste containing a glass frit, a paste-forming medium, conductive particles made of silver and particles containing non-precious metal, in order to produce a conductive coating on glass, ceramics or enameled steel, a method for producing said coating and articles coated therewith. According to the invention, the conductive particles containing non-precious metal correspond to up to 80 wt. % of all conductive particles, and are essentially made up of iron, cobalt, nickel, copper, zinc or an alloy containing at least one of these elements, especially nickel, and have an average particle size d₅₀ ranging from 0.1-15 μm and a specific surface ranging from 0.5-10 m²/g. The glass frits begin to soften at 350° C.-600° C. and have a hemisphere temperature of 450° C.-700° C.

The invention relates to a conductivity paste for the purpose of producing electrically conductive coatings, in particular conductor tracks, on glass, ceramic or enamelled steel. Further subjects of the invention are focused upon a process for producing the conductive coatings and also upon articles having a conductive coating of such a type on glass, ceramic or enamelled steel, such as, in particular, panes of glass with electrical conductor tracks.

For electrical and electronic purposes, panes of glass and ceramic substrates are often provided with conductor tracks or are provided with a conductive layer over their entire surface, whereby the coating that has been stoved on the substrate contains one or more metals imparting electrical conductivity and also a glass composition by way of binding agent and coupling agent on the substrate. Depending on their end use, conductive coatings of such a type mostly contain one or more noble metals by way of conductivity metal. In certain fields the noble metals have been able to be replaced, in part or completely, by other metals such as aluminium and silicon.

According to U.S. Pat. No. 4,039,721, thick-film conductor tracks are obtained on a ceramic substrate by a paste containing silver powder, aluminium powder and a borosilicate glass frit being applied onto the substrate by means of screen printing and being stoved at 800° C.-1100° C. The particle diameter of the silver powder is below 10 μm; that of the aluminium powder lies within the range from 6 μm to 20 μm.

In the case of the paste-forming medium, it is a question of a solution of ethyl cellulose in isomers of terpene alcohol. A disadvantage of this paste is that it has to be stoved at high temperatures and therefore does not enter into consideration for the production of conductive coatings on glass.

EP 1 087 646 A2 teaches a process for producing a conductive coating on glass, wherein the screen-printable aluminium paste to be used contains 40-80 wt. % aluminium powder with a d₅₀ value within the range from 1 μm to 10 μm, 5-40 wt. % of one or more glass frits having a softening-temperature within the range from 400° C. to 700° C., 10-35 wt. % of a liquid or thermoplastic medium and, optionally, 0-40 wt. % silver powder. The resistivity of the conductive coating increases with increasing content of glass frits in the paste. Although, according to this process, conductive coatings on glass can be obtained having a resistivity within the range from about 25 μΩ·cm to over 100 μΩ·cm, the resistivity depends to a considerable extent on the chosen stoving temperature. Both a lowering and an increase of the firing temperature by more than 10° C. in relation to the optimal firing range for a given system under consideration can quickly lead to a doubling of the resistivity. The increase in the resistivity is ascribed to incomplete sintering or, to be more exact, oxide-formation. A further disadvantage of these aluminium-containing conductivity pastes consists in the fact that the conductive coatings obtained therewith necessitate quite special soldering processes, for example ultrasonic soldering using a very special solder tin.

For the purpose of producing heatable rear windows of motor vehicles, at the present time conductive pastes based on silver powders are used substantially exclusively. The electrical properties of the pastes are matched to the customary voltages of 12 V. Conductor tracks on motor-vehicle glass that have been produced using commercial silver pastes have a resistivity within the range from 2.5 μΩ·cm to 12 μΩ·cm.

Efforts are being made to increase the voltage in motor vehicles above 12 V, for example to a value within the range from 24 V to 42 V. In the event of an increase in the voltage by a factor of 2 or 3, for the same power of a heatable rear window of a motor vehicle the electrical resistance of the conductor track has to be increased by a factor of 4 or 9, respectively. The composition of the conductivity paste has to be changed accordingly, so that the stoved electrically conductive coatings exhibit the resistivity that is demanded. But at the same time the solderability, the chemical resistance, the adhesion of the coating on the substrate and also the compatibility with ceramic pigments which are optionally present ought to approximate as much as possible to the properties of the hitherto conventional silver pastes. A further requirement of conductivity pastes is focused upon an optimal stability of the resistivity, depending on the stoving temperature. For example, the resistivity of a coating on glass at a temperature within the range from approximately 650° C. to 700° C., in particular 660° C.-680° C., ought to vary by less than 15%, preferably by less than 10%.

With a view to producing conductor tracks having a resistivity within the range of approximately 25-60 μΩ·cm, screen-printing pastes are commercially obtainable (for example, SP1216 and SP1217 manufactured by the applicant) that can be stoved in the fast-firing process at a temperature within the range from 600° C. to 680° C. These pastes contain silver conductivity particles, a low-melting glass frit, pigments and a paste-forming medium. A disadvantage of these pastes is that they are solderable only with special processes (ultrasound) and additionally exhibit low stability in relation to the stoving temperature—as the Comparative Examples in the present application show, the resistivity rises by approximately 20% if the stoving temperature is lowered from 670° C. to 660° C.

Accordingly, the object of the present invention is to demonstrate a conductivity paste for the purpose of producing a conductive coating on glass, ceramic or enamelled steel that exhibits higher stability in relation to the stoving temperature. In particular, the resistivity of an electrically conductive coating on glass obtained by using such a paste, which has been stoved using fast firing at a temperature within the range from 660° C. to 680° C., should vary by less than 10%, preferably less than 5%. According to a further object, the electrically conductive coatings that are produced by using a conductivity paste according to the invention should be capable of being soldered under conventional conditions; accordingly, they should not necessitate any special soldering processes such as ultrasonic soldering or soldering under protective-gas atmosphere. According to a further object of the invention, it should be possible, through a simple change in the quantity of an essential constituent of the conductivity paste, to change the resistivity in substantially uniform manner, that is to say, not abruptly. Further objects will become apparent from the following description of the invention in its different embodiments.

A conductivity paste has been found for the purpose of producing a conductive coating on glass, ceramic or enamelled steel, comprising conductivity particles of silver, conductivity particles containing at least one base metal, one or more glass frits and a paste-forming medium, said conductivity paste being characterised in that the conductivity particles containing base metal consist substantially of iron, cobalt, nickel, copper, zinc or an alloy containing at least one of these elements and additionally may be coated with silver, the conductivity particles containing base metal exhibit a mean particle size d₅₀ within the range from 0.1 μm to 15 μm and a specific surface within the range from 0.5 m²/g to 10 m²/g, up to 80 wt. % of all the conductivity particles are conductivity particles containing base metal, and the one or more glass frits exhibit a softening-temperature (heating microscope) within the range from 350° C. to 600° C. and a hemisphere temperature within the range from 450° C. to 700° C.

The remaining claims are focused upon preferred embodiments of the conductivity paste, upon the use thereof, a process for producing the electrically conductive coating by using the conductivity paste and also upon articles having a conductive coating on glass, ceramic or enamelled steel, which are obtainable by using a conductivity paste according to the invention.

It has been found that a conductivity paste that contains, besides silver conductivity particles, special base-metal conductivity particles and additionally a low-melting glass flux consisting of one or more glass frits, after application on a substrate and after a conventional firing, in particular a fast firing at a temperature within the range from 650° C. to approximately 700° C., results in an electrically conductive coating that exhibits a resistivity greater than that which is obtainable by using a conductivity paste comprising exclusively silver conductivity particles. By increasing the proportion of base-metal conductivity particles, relative to the overall quantity of conductivity particles, the resistivity of an electrically conductive coating produced from said particles can be increased in substantially uniform manner, so that coatings having a resistivity within the range from 10 μΩ·cm to over 100 μΩ·cm are obtainable without any problems.

Property discontinuities, such as have been known from conductivity pastes containing silver and aluminium, do not arise in the case of the conductivity pastes according to the invention, or they arise to a substantially lesser extent. Accordingly, the conductivity pastes according to the invention are also distinguished by high stability in relation to the stoving temperature. For practical use, this means that in the event of a deviation of the firing temperature of ±10° C. from a value that is being striven for, the resistivity of the coating that is obtained in the given case differs by less than 10%, in particular less than 7%, from the value that is obtained at the firing temperature that is being striven for. The optimal temperature range for firing depends, on the one hand, upon the softening behaviour of the glass frits contained in the paste and also upon the sintering temperature of the conductivity particles containing base metal. The demonstrated advantage of conductivity pastes according to the invention is accordingly focused upon a firing temperature above the highest hemisphere temperature of the glass frits that are present and preferably above the temperature at which the conductivity particles agglomerate at least partially.

A significant advantage of conductivity pastes according to the invention consists in the fact that said conductivity pastes can be soldered in straightforward manner by conventional means and with conventional solder-tin materials for the metals contained in the paste. Elaborate devices for ultrasonic soldering, or soldering under protective-gas atmosphere, are accordingly not necessary.

The conductivity pastes according to the invention contain, by way of conductivity materials, both particles of silver and particles that contain at least one base metal. In the case of the particles containing base metal, it is a question, in particular, of particles of iron, cobalt, nickel, copper, zinc and also alloys that contain at least one of these metals. By way of further alloy constituent, the alloys may contain a further element from the stated series or a different metal, such as silicon, vanadium, chromium, manganese, silver and tin. According to a preferred embodiment, the conductivity paste contains nickel particles or copper particles by way of particles containing base metal. In the case of pastes containing nickel or copper, the content of base metal preferably lies below 50 wt. %, in particular within the range from 5 wt. % to 40 wt. %, relative to all conductivity particles. According to a form that is particularly preferred with respect to its combination of properties, the paste contains substantially exclusively silver particles and nickel particles by way of conductivity particles.

Pastes containing silver particles and bronze particles display a surprisingly low resistivity despite a very high proportion of bronze, amounting to around 70 wt. % for example. The saving on silver here is advantageous.

It is also possible for the conductivity particles containing base metal to be coated with a thin covering of silver. Coatings of such a type can be obtained in a manner known as such by reduction of a silver compound from aqueous phase on the surface of the base metal. Base-metal-containing particles coated with silver are suitable, in particular, for use in pastes that are intended to provide a coating having relatively low resistivity.

Conductivity pastes according to the invention contain silver particles with a particle-size range and with a specific surface such as find application in silver conductivity pastes known previously. In this connection, microcrystalline powders of substantially spherical shape exhibit a mean particle diameter d₅₀ of less than 6 μm and a specific surface from 1 m²/g to 2 m²/g. In the case of silver particles that can be used alternatively, it is a question of a powder consisting of lamelliform particles having a mean diameter within the range from 7 μm to 11 μm and a specific surface in the region of 1.5 m²/g. Silver particles having a mean particle diameter and a specific surface outside the stated ranges can also be employed. Ordinarily, the mean particle diameter d₅₀ will lie within the range from 0.1 μm to 15 μm, preferably 1 μm to 10 μm. The specific surface of the silver particles expediently lies within the range from 0.5 m²/g to 5 m²/g.

The conductivity particles containing base metal generally exhibit a mean particle size d₅₀ within the range from 0.1 μm to 15 μm, in particular 0.2 μm to 10 μm. The specific surface of the conductivity particles containing base metal, measured in accordance with BET (N₂ absorption) or from calculations derived from the particle-size range, expediently lies within the range from 0.5 m²/g to 10 m²/g, preferably within the range from 1 m²/g to 5 m²/g.

As already explained, the resistivity of the electrically conductive coating can be controlled by means of the quantitative proportion of conductivity particles containing base metal, whereby the resistivity increases with increasing quantity of these particles containing base metal. Although just a small quantity of conductivity particles containing base metal, such as 0.1 wt. % to 1 wt. %, relative to the sum of the conductivity particles, already leads to an increase in the resistivity, conductivity pastes according to the invention usually contain more than 1 wt. %, preferably 5 wt. % to 40 wt. %, particularly preferably 10 wt. % to 35 wt. %, conductivity particles containing base metal.

Through the use of one or more glass frits by way of glass flux in the conductivity paste according to the invention, the high stability of the paste in relation to the stoving temperature is obtained. At the same time, it has become possible to keep the quantity of glass flux at a low level. Ordinarily, the paste contains 1 wt. % to 12 wt.% of one or more glass frits, preferably 2 wt. % to 10 wt. %. The glass frits are employed in the granularity that is conventional for coating purposes. Ordinarily, the d₅₀ value lies within the range from 0.5 μm to 10 μm, preferably within the range from 1 μm to 5 μm. Expediently the d₅₀ value is less than 15 μm, in particular less than 10 μm, and the d₅₀ value is greater than 0.2 μm, preferably greater than 0.5 μm. A glass frit having a particle-size range within the range of the aforementioned values is very well suited for the use of a screen-printable conductivity paste. The glass frits to be used in accordance with the invention exhibit a low softening-temperature, namely within the range from 350° C. to 600° C., and a low hemisphere temperature, namely within the range from 450° C. to 700° C. In the case of the hemisphere temperature, the radius of the basal surface corresponds to the height of the compact that has been melted to form a hemisphere, with both a diameter and a height of 3 mm. Both the softening-temperature and the hemisphere temperature are expediently ascertained in the heating microscope in respect of standardised cylindrical compacts of the glass-frit powder.

Both lead-borosilicate glass frits and lead-free glass frits can be employed. Amongst the lead-free glass frits, glass frits containing zinc, glass frits containing bismuth or glass frits containing zinc and bismuth are well suited. In the case of another class of suitable glass frits, it is a question of those based on SiO₂, B₂O₃, TiO₂ and K₂O by way of essential components. Experts in the field are well acquainted with glass frits of such a type having a softening behaviour within the requisite temperature range. Exemplary frit compositions with their obligatory components can be gathered from the following documents:

EP 0 790 220 B (in mol. %): SiO₂ 30-55, B₂O₃ 10-25, TiO₂ 15-30, K₂O 10-17;

EP 0 728 710 B (in mol. %): SiO₂ 40-50, B₂O₃ 8-14, ZnO 13-19, TiO₂ 4-7, Na₂O 10-15, K₂O 0.1-2, F 1-5, Al₂O₃ 0.1-3;

EP 0 267 154 B (in mol. %): SiO₂ 45-60, B₂O₃ 6-13, ZnO 8-25, Na₂O 5-14;

EP 0 558 942 (in mol. %): SiO₂ 10-44, B₂O₃ 11-35, ZnO 31-50, Na₂O 11-25;

EP 0 854 120 A (in wt. %): SiO₂ 10-25, B₂O₃ 2-20, ZnO 3-15, Bi₂O₃ 20-55, Na₂O 1-10;

EP 0 803 480 A (in wt. %): SiO₂ 10-25, B₂O₃ 20-40, ZnO 10-50, Bi₂O₃ 0-15, Na₂O 7-10;

U.S. Pat. No. 5,714,420 (in wt. %): SiO₂ 20-35, B₂O₃ 5-15, ZnO 5-45, Bi₂O₃ 10-50, Na₂O.

With a view to modifying the electrically conductive coating with regard to the electrical properties, the adhesion of the coating on the substrate, the scratch resistance and also the colour, modifying components may be added to the conductivity paste to a limited extent. In the case of these modifying components, it is a question of, for example, colour-imparting pigments such as metal sulfides, such as zinc sulfide for the purpose of reducing the migration of silver ions during firing, oxide-forming precursors such as resinates for the purpose of modifying the electrical properties and/or the adhesion on the substrate. The modifying components may be contained in the conductivity paste in a quantity of up to approximately 15 wt. %. Of course, the resistivity of the stoved conductive coating is increased with increasing quantity of, for example, oxidic modification components. If a resistivity is to amount to around/below 50 μΩ·cm, the content of modifying components will generally lie below 10 wt. %, preferably below 5 wt. %, relative to the paste.

According to a further embodiment, in the case of the modifying components it may also be a question of pulverulent auxiliaries that, at a given firing temperature, result in a higher degree of sintering of the silver particles and also of the conductivity particles containing base metal. Examples of sintering aids are metals such as zinc, magnesium, boron and silicon, in particular zinc and magnesium, zinc having already been named among the conductivity particles containing base metal. A further class of sintering aids is constituted by fluorides such as cryolite (AlF₃. 3NaF), NaF, MgF₂, and also carbon. The effect of the sintering aids may consist in the lowering of the melting-point and/or in their reducing action during firing.

An essential constituent of conductivity pastes according to the invention is also a liquid or thermoplastic medium in which the conductivity particles, the glass frits and the optionally present modifying components are uniformly dispersed. Preferred are liquid organic media that contain one or more polymeric binding agents and/or one or more solvents. The content of binding agent in the medium is chosen so that, after drying, the film that is obtained by means of a coating process, for example a screen-printing process, is sufficiently resistant to touch. Particularly suitable is a quantity of binding agent within the range from 0.5 wt. % to 10 wt. %, in particular 1 wt. % to 5 wt. %, relative to the conductivity paste.

The choice of binding agent is not particularly critical, insofar as the binding agents decompose and/or burn off under the conditions of firing and in the process volatilise completely. Suitable are, for example, cellulose ethers, acrylic and methacrylic esters, natural resins, rosins and modified alkyd resins.

In the case of the organic solvents as a constituent of the medium, it is a question of those which volatilise in blister-free manner in the course of firing, are able to dissolve the binding agent and enable the adjustment of a suitable processing viscosity of the conductivity paste. Examples are terpene alcohols and terpene hydrocarbons, glycols, diglycols and triglycols as well as ethers and esters of the same; cyclic and branched hydrocarbons, such as isoparaffins with a boiling-point within the range from 160° C. to 250° C.; alcohols, ethers and esters with a boiling-point within the range from 70° C. to 250° C., in particular 100° C. to 220° C. The quantity of solvent required is dependent upon the desired viscosity. The conductivity paste to be used in accordance with the invention can be produced in the manner that is conventional for ceramic printing pastes, namely by intensive mixing of the components, for example in a three-roll mill, in a dispersant or in a ball mill.

According to a preferred embodiment, the conductivity paste contains 40 wt. % to 85 wt. % conductivity particles, with silver particles and nickel particles being particularly preferred, 1 wt. % to 12 wt. % glass frit(s), 10 wt. % to 50 wt. % medium and 0 wt. % to 15 wt. % substances for modification. According to a particularly preferred embodiment, the paste contains 50 wt. % to 80 wt. % conductivity particles, 2 wt. % to 10 wt. % glass frit(s), 15 wt. % to 48 wt. % medium and 0 wt. % to 15 wt. % substances for modification.

According to a particularly preferred embodiment, in the case of the glass frits to be used it is a question of those which are fast-firable, that is to say, those which can be stoved on glass within approximately 1 to 10 minutes, but preferably 2 to 5 minutes at a temperature within the range from 660° C. to 680° C. The conductivity pastes according to the invention can be used for the purpose of producing conductive coatings on firable substrates, that is to say, in particular, glass, ceramic and enamelled steel. The production of a coating of such a type comprises the application of a layer of a conductivity paste onto the substrate and a firing of the coated substrate at a temperature within the range from 450° C. to 700° C.

Application of the conductivity paste according to the invention is undertaken by means of conventional processes such as are known from the production of decorations on glass or ceramic. It is a question of conventional direct and indirect printing processes, in particular screen-printing processes. Application by spraying, dipping or by means of other decoration-application techniques is also possible.

In the case of the substrates to be coated, it is a question of those made of glass, ceramic or enamelled steel, in particular panes of glass, such as panes of glass for motor vehicles.

Firing of the coated substrate is effected at a temperature that is matched to the substrate, to the softening behaviour of the glass frit(s) present and also to the sintering behaviour of the conductivity metals. In view of the ordinarily low softening-point of the glass frit contained in a conductivity paste according to the invention, firing is effected at a temperature within the range from approximately 550° C. to 750° C., preferably 590° C. to 700° C., and particularly preferably 650° C. to 690° C. On panes of glass for motor vehicles the conductivity paste is expediently stoved under conditions such as are conventional when using previous conductivity pastes and/or other decorative preparations. Usually in this connection it is a question of a so-called shock firing or fast firing, whereby stoving is effected at a temperature within the range from approximately 640° C. to 700° C., preferably 650° C. to 700° C., and particularly preferably 660° C. to 680° C., within 1 minute to 10 minutes, preferably 2 minutes to 5 minutes.

The invention also provides articles having a conductive coating on glass, ceramic or enamelled steel, the coating being obtainable by using a conductivity paste according to the invention.

The advantages of the conductivity pastes according to the invention have already been presented. Corresponding advantages are also exhibited by the articles obtainable in accordance with the invention having an electrically conductive coating that has been obtained by using a conductivity paste according to the invention.

The invention will be elucidated further on the basis of the following Examples and Comparative Examples.

### EXAMPLES

With a view to producing the conductivity pastes according to the invention, the following components were employed:

Ag powder type “3X”: microcrystalline type: d₅₀ less than 6 μm, specific surface 1.1-1.8 m²/g (manufacturer's data)

Ag flakes type “D12”: lamelliform type, d₅₀ 7-11 μm, specific surface 1.0-1.5 m²/g (manufacturer's data)

Ni powder: d₅₀ 5-6 μm, specific surface 3.9 m²/g

Cu powder: d₅₀ 5-6 μm, specific surface 2-3 m²/g

bronze powder: d₅₀ 5-6 μm, specific surface 1.5-2.5 m²/g

glass flux “GF1”: it is a question of a glass frit containing zinc oxide and having the principal components (wt. %): ZnO (37), B₂O₃ (22), SiO₂ (11), Na₂O (11), Al₂O₃ (5); softening-temperature 530° C., hemisphere temperature 630° C., d₅₀ 2-3 μm

glass flux “GF2”: it is a question of a glass frit containing zinc oxide and bismuth oxide and having the principal components (wt. %): Bi₂O₃ (42), ZnO (15), B₂O₃ (11), SiO (21), Na₂O (5), TiO₂ (1.5), ZrO₂ (1.5); softening-temperature 550° C., hemisphere temperature 680° C., d₅₀ 2-3 μm

medium: hydroxypropyl cellulose (5 wt. %) in diethylene glycol n-butyl ether

SP1216: the silver paste of CE1 contains 45 wt. % Ag, about 5 wt. % glass frit, approximately 16 wt. % pigments and 34 wt. % medium.

Table 1 shows paste compositions and the special resistance after application by means of screen printing and firing at 670° C. in a continuous furnace for 4 minutes.

| | Ag type | | | | | | |
|---|---|---|---|---|---|---|---|
| | wt. % | | | Glass frit | | | |
| | crystal- | lamel- | Nickel | wt. % | | Medium | Resistivity |
| No. | line | liform | wt. % | GF1 | GF2 | wt. % | μΩ · cm |
| 1 | 34.5 | — | 34.5 | 6 | — | 25 | 550 |
| 2 | 46.3 | — | 22.7 | 6 | — | 25 | 70 |
| 3 | 51.7 | — | 17.3 | 6 | — | 25 | 40 |
| 4 | 55.4 | — | 13.6 | 6 | — | 25 | 29 |
| 5 | 51.7 | — | 17.3 | 2 | 4 | 25 | 40 |
| 6 | 25.8 | 25.8 | 17.3 | 2 | 4 | 25 | 39 |

Table 2 shows the stability of pastes Nos. 5 and 6 in comparison with a commercial silver paste (SP1216) (=CE1). Firing was effected at 660° C., 670° C. and 680° C. in a continuous furnace, in each case for 4 minutes. Whereas the resistivity of the pastes according to the invention depends only slightly on the firing temperature, a large temperature dependence results in the case of the paste of CE1.

TABLE 2

| | Firing Temperature | Resistivity |
|---|---|---|
| No. | (° C.) | μΩ · cm |
| CE1 | 660 | 31 |
| | 670 | 25.8 |
| | 680 | 24.7 |
| 5 | 660 | 37.8 |
| | 670 | 40.1 |
| | 680 | 38.2 |
| 6 | 660 | 39.7 |
| | 670 | 38.5 |
| | 680 | 38.3 |

The pastes according to the invention display good solderability using known processes such as generally find application in the automobile-glass industry; paste No. 6 displays the best solderability.

Table 3 shows the composition and the resistivity of pastes containing copper powder or bronze powder. The pastes each contained 6 wt. % of the glass frit GF1 and 25 wt. % of the medium. Firing was effected at 670° C. for 4 minutes in a continuous furnace.

TABLE 3

| | | |
|---|---|---|
| Ag type | Base metal | |
| crystalline | (wt. %) | Resistivity |

| No. | (wt. %) | Cu | Bronze | (μΩ · cm) |
|---|---|---|---|---|
| 7 | 34.5 | 34.5 | | 76.2 |
| 8 | 42.8 | 26.2 | | 30.9 |
| 9 | 46.3 | 22.7 | | 22.4 |
| 10 | 20.1 | | 48.9 | 34.6 |
| 11 | 34.5 | | 34.5 | 10.6 |
| 12 | 46.3 | | 22.7 | 5.8 |

1. A conductivity paste for the purpose of producing a conductive coating on glass, ceramic or enamelled steel, comprising conductivity particles of silver, conductivity particles containing at least one base metal, one or more glass frits and a paste-forming medium,
characterised in that
the conductivity particles containing base metal consist substantially of iron, cobalt, nickel, copper, zinc or an alloy containing at least one of these elements and additionally may be coated with silver, the conductivity particles containing base metal exhibit a mean particle size d₅₀ within the range from 0.1 μm to 15 μm and a specific surface within the range from 0.5 m²/g to 10 m²/g, up to 80 wt. % of all conductivity particles are conductivity particles containing base metal and the one or more glass frits exhibit a softening-temperature (heating microscope) within the range from 350° C. to 600° C. and a hemisphere temperature within the range from 450° C. to 700° C.

2. Conductivity paste according to claim 1,
characterised in that
by way of conductivity particles containing base metal it contains nickel particles or copper particles in a quantity of up to 50 wt. %, in particular 10 wt. % to 40 wt. %, relative to the sum of conductivity particles.

3. Conductivity paste according to claim 1 or 2,
characterised in that
it contains more than 5 wt. %, in particular 10 wt. % to 35 wt. %, conductivity particles containing base metal, relative to the sum of all conductivity particles.

4. Conductivity paste according to any one of claims 1 to 3, characterised in that
it contains in wt. %:

| | |
|---|---|
| conductivity particles | 40-85 |
| glass frit(s) | 1-12 |
| medium | 10-50 |
| substances for modification | 0-15 |

5. Conductivity paste according to claim 4,
characterised in that
it contains in wt. %:

| | |
|---|---|
| conductivity particles | 50-80 |
| glass frit(s) | 2-10 |
| medium | 15-48 |
| substances for modification | 0-15 |

6. Conductivity paste according to any one of claims 1 to 5, characterised in that
the glass frit(s) is/are lead-free and is/are selected from the series of the zinc-containing and/or bismuth-containing borosilicate glasses or glasses based on the principal components SiO₂, B₂O₃, TiO₂ and K₂O.

7. Conductivity paste according to any one of claims 1 to 6, characterised in that
the glass frit(s) is/are fast-firable (2-5 min at 660° C. to 680° C. on glass).

8. Conductivity paste according to any one of claims 1 to 7, characterised in that
the conductivity particles exhibit a specific surface within the range from 1 m²/g to 5 m²/g.

9. Conductivity paste according to any one of claims 1 to 8, characterised in that
the paste-forming medium contains an organic binding agent, in particular a cellulose derivative, and one or more solvents, in particular glycol-ether compounds and terpene alcohols, or is substantially based on a thermoplastic polymer.

10. Conductivity paste according to any one of claims 1 to 9, characterised in that
the paste is screen-printable.

11. Use of the conductivity paste according to one of claims 1 to 10 for the purpose of producing a conductive coating on a firable substrate, in particular glass, ceramic or enamelled steel.

12. A process for producing a conductive coating on a firable substrate, in particular glass, ceramic or enamelled steel, comprising applying a layer of a conductivity paste onto the substrate and firing the coated substrate at a temperature within the range from 450° C. to 700° C.,
characterised in that
use is made of a conductivity paste according to one of claims 1 to 10.

13. Articles having a conductive coating on glass, ceramic or enamelled steel,
characterised in that
the coating is obtainable by using a conductivity paste according to any one of claims 1 to 10.
